(19) United States
(12) Patent Application Publication
(10) Pub. No.: US 2025/0005774 A1
(43) Pub. Date: Jan. 2, 2025

(54) BIT RATE CONTROL DEVICE AND BIT RATE CONTROL METHOD

(71) Applicant: SigmaStar Technology Ltd., Xiamen (CN)

(72) Inventors: Chuan HE, Shanghai (CN); Yu YE, Shanghai (CN); Ling-Ying NAIN, Zhubei City (TW)

(21) Appl. No.: 18/734,063

(22) Filed: Jun. 5, 2024

(30) Foreign Application Priority Data
Jun. 28, 2023 (CN) 202310778620.7

(51) Int. Cl. G06T 7/40; G06T 5/20; G06T 7/20; G06T 7/90

(52) U.S. Cl. CPC G06T 7/40; G06T 5/20; G06T 7/20; G06T 7/90; G06T 2207/20036; G06T 2207/30196

(57) ABSTRACT

A rate control device includes a confidence calculation circuit, a blend calculation circuit and a bit distribution circuit. The confidence calculation circuit calculates a texture confidence, a person confidence and a motion confidence according to an image. The blend calculation circuit determines, according to a mode selection signal, whether to select one of the person confidence and the motion confidence for blend calculation with the texture confidence to generate a blend parameter. The bit distribution circuit generates a bit distribution parameter according to the blend parameter.

This application claims the benefit of China application Serial No. CN202310778620.7, filed on Jun. 28, 2023, the subject matter of which is incorporated herein by reference.

### BACKGROUND OF THE INVENTION

### Field of the Invention

The present application relates to a bit rate control device and a bit rate control method, and more particularly, to a rate control device and a rate control method which determine a bit distribution mode using one or more confidences.

### Description of the Related Art

A conventional perceptual macroblock-level rate (PMBR) control technique is primarily based on visual prominence as a weighting for rate distribution. As the visual prominence increases, the weighting increases and a corresponding quantization parameter (QP) decreases. A modeling method of the visual prominence above mainly relies on such as a gradient of the luminance component, the luminance component, a variance of the luminance component and motion information.

However, even if the PMBR technique uses the visual prominence above for regulation, it remains challenging to completely reflect the effect of the regulation on subjective viewing quality of a user. Moreover, modeling based on the luminance component faces a great restriction. Modeling based on the gradient of the luminance component contains issues of unsatisfactory improvement in details and severe mosaic effects on flat regions. In addition, as the number of metrics taken into consideration by the visual prominence gets larger, the improvement on subjective viewing quality of a user further diminishes. Furthermore, a bit rate control policy executed based on the quantization parameters also leads to insufficient accuracy of bit control. If an intensity of the PMBR control cannot be freely regulated, application scenarios may also be seriously limited.

### SUMMARY OF THE INVENTION

In view of the drawbacks of the prior art, it is an object (for example but not limited to) of the present application to provide a bit rate control device so as to improve the prior art.

In some embodiments, a bit rate control device includes a confidence calculation circuit, a blend calculation circuit and a bit distribution circuit. The confidence calculation circuit calculates a texture confidence, a person confidence and a motion confidence according to an image. The blend calculation circuit determines, according to a mode selection signal, whether select one of the person confidence and the motion confidence for blend calculation with the texture confidence to generate a blend parameter. The bit distribution circuit generates a bit distribution parameter according to the blend parameter.

In some embodiments, a bit rate control method is applied to a bit rate control device. The bit rate control method includes: calculating a texture confidence, a person confidence and a motion confidence according to an image; determining, according to a mode selection signal, whether to select one of the person confidence and the motion confidence for blend calculation with the texture confidence to generate a blend parameter; and generating a bit distribution parameter according to the blend parameter.

The bit rate control device and the bit rate control method of the present application, in response to different application scenarios, are able to selectively determine whether to select one of the person confidence and the motion confidence for blend calculation with the texture confidence to generate a blend parameter and then accordingly determine an encoding parameter such as a bit distribution parameter, thereby improving viewing quality of a person part (for example, a human face) or a motion part.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a video encoding system according to some embodiments of the present application;

FIG. 2 is a schematic diagram of a bit rate control device according to some embodiments of the present application;

FIG. 3 is a schematic diagram of a texture confidence calculator according to some embodiments of the present application;

FIG. 4 is a schematic diagram of a gradient direction according to some embodiments of the present application.

FIG. 5 is a schematic diagram of a person confidence calculator according to some embodiments of the present application;

FIG. 6 is a schematic diagram of a skin color region according to some embodiments of the present application;

FIG. 7 is a schematic diagram of a bit rate control device according to some embodiments of the present application;

FIG. 8 is a schematic diagram of a blend sub-circuit according to some embodiments of the present application;

FIG. 9 is a schematic diagram of an adjustment strength according to some embodiments of the present application; and

FIG. 10 is a flowchart of a bit rate control method according to some embodiments of the present application.

### DETAILED DESCRIPTION OF THE INVENTION

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

In the field of video encoding, under the restriction of transmission bandwidth, it is necessary to efficiently apply a video encoding scheme under such limited transmission bandwidth, so as to improve subjective viewing quality. To achieve the above object, the present application provides a video encoding system and a bit rate control device to be described in detail below.

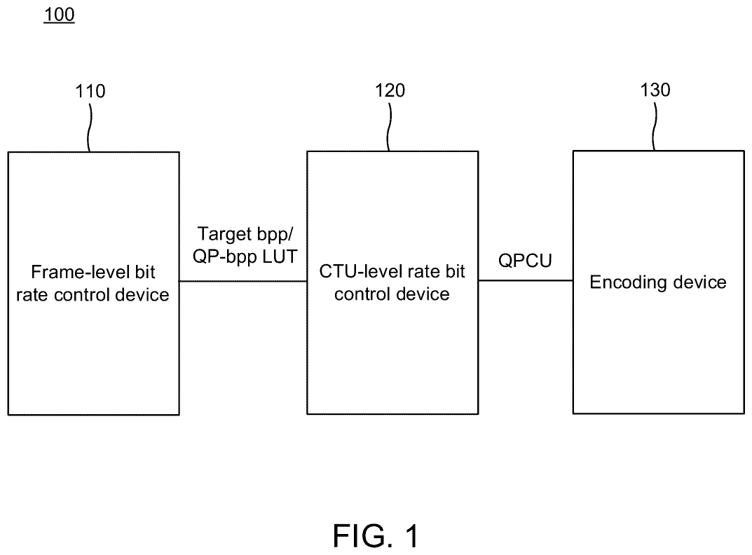

FIG. 1 shows a schematic diagram of a video encoding system 100 according to some embodiments of the present application. As shown in FIG. 1, the video encoding system 100 includes a frame-level bit rate control device 110, a coding-tree unit (CTU)-level bit rate control device 120 and an encoding device 130. The video encoding system 100 analyzes an input image by the frame-level bit rate control device 110 and the CTU-level bit rate control device 120 to determine an encoding parameter such as an encoding bit rate, and completes video encoding by the encoding device 130.

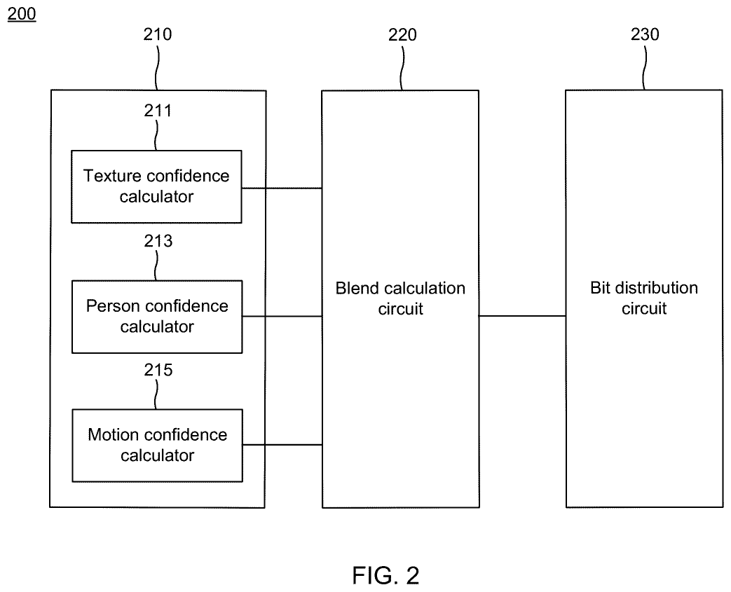

FIG. 2 shows a schematic diagram of a bit rate control device 200 according to some embodiments of the present application. As shown in the drawing, the bit rate control device 200 includes a confidence calculation circuit 210, a blend calculation circuit 220 and a bit distribution circuit 230. In some embodiments, the bit rate control device 200 is primarily applied in the CTU-level bit rate control device 120 of the video encoding system 100 in FIG. 1.

In some embodiments, the confidence calculation circuit 210 calculates a texture confidence, a person confidence and a motion confidence according to an input image. Then, the blend calculation circuit 220 determines, according to a mode selection signal, whether to select one of the person confidence and the motion confidence for blend calculation with the texture confidence to generate a blend parameter. Next, the bit distribution circuit 230 generates a bit distribution parameter according to the blend parameter.

The bit rate control device 200 of the present application is operable in a first mode according to the mode selection signal and perform bit distribution by using the texture confidence as a reference. Thus, the bit rate control device 200 is able to save code words by using macroblocks having high texture confidences. Moreover, the bit rate control device 200 is also operable in a second mode according to the mode selection signal, so as to blend the texture confidence and the person confidence to perform bit distribution. As such, the bit rate control device 200 is able to distribute more code words for macroblocks associated with persons, so as to improve subjective viewing quality of a person part (for example, a human face). Moreover, the bit rate control device 200 is further operable in a third mode according to the mode selection signal, so as to blend the texture confidence and the motion confidence to perform bit distribution. As such, the bit rate control device 200 is able to distribute more code words for macroblocks associated with motion, so as to improve subjective viewing quality of a motion part.

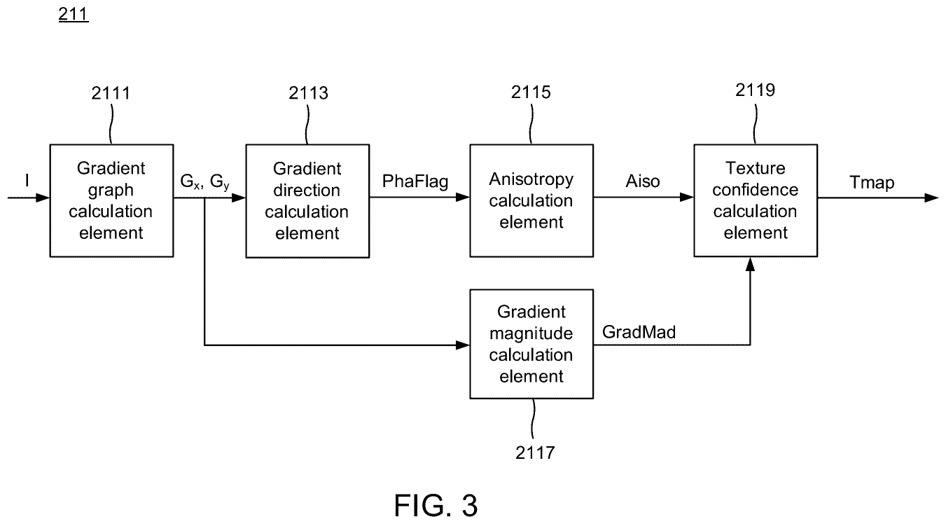

In some embodiments, the confidence calculation circuit 210 includes a texture confidence calculator 211. To better understand the operation of the texture confidence calculator 211, referring to both FIG. 2 and FIG. 3, FIG. 3 shows a schematic diagram of the texture confidence calculator 211 according to some embodiments of the present application.

As shown in FIG. 3, the texture confidence calculator 211 includes a gradient graph calculation element 2111, a gradient direction calculation element 2113, an anisotropic calculation element 2115, a gradient magnitude calculation element 2117 and a texture confidence calculation element 2119.

In some embodiments, the gradient graph calculation element 2111 performs convolution on an input image I to obtain at least two gradient graphs Gₓ and G_{y}. For example, the gradient graph calculation element 2111 may perform 8× sampling on an original frame of the input image I to obtain a plurality of macroblocks, each of which having dimensions of 8×8. The gradient graph calculation element 2111 performs convolution on the input image I according to an operator Kₓ in the X direction and an operator K_{y} in the Y direction to obtain gradient graphs Gₓ and G_{y}, using equations below:

$${K}_{x} = [ 10 - 1 ] \qquad Equation ( 1 )$$

$${K}_{y} = {[ - 101 ]}^{T} \qquad Equation ( 2 )$$

$${G}_{x} ( i , j ) = {\sum }_{m = - 1}^{1} I ( i , j + m ) {K}_{x} ( m ) \qquad Equation ( 3 )$$

$${G}_{y} ( i , j ) = {\sum }_{m = - 1}^{1} I ( i + m , j ) {K}_{y} ( m ) \qquad Equation ( 4 )$$

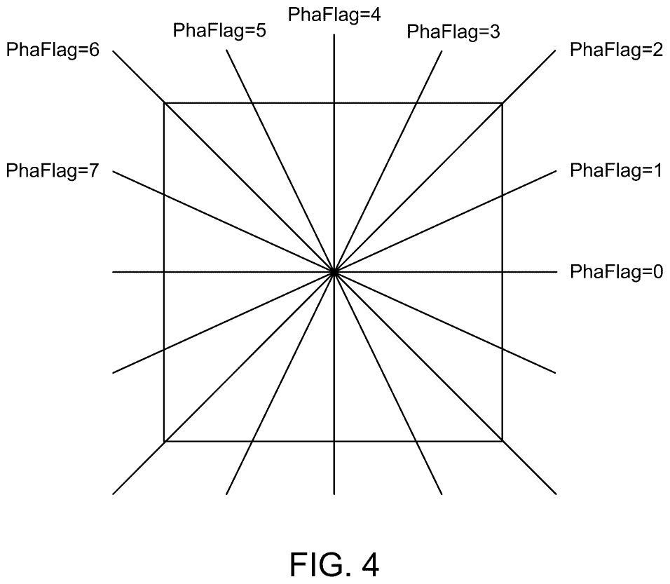

In some embodiments, after at least two gradient graphs Gₓ and G_{y} are obtained, the gradient direction calculation element 2113 calculates at least two gradient directions PhaFlag according to the at least two gradient graphs Gₓ and G_{y}. For example, the gradient direction calculation element 2113 calculates 8 gradient directions PhaFlag according to the gradient graphs Gₓ and G_{y}. To better understand the calculation for the gradient direction PhaFlag, referring to both FIG. 3 and FIG. 4, FIG. 4 shows a schematic diagram of a gradient direction PhaFlag according to some embodiments of the present application.

Referring to both FIG. 3 and FIG. 4, to better implement the gradient direction calculation element 2113, the present application set an equation below:

$$PhaFlag = mod ( arc tan ( Gy / Gx ) , π / 8 ) \qquad Equation ( 5 )$$

In equation (5), PhaFlag is the gradient direction, mod is a remainder operation, arctan is an arctangent function, a value range of arctan is in (−π/2, π/2) and this can convert angles in the second and third quadrants to the first and fourth quadrants. Refer to the following equations:

$$if {G}_{x} < 0 and {G}_{y} > 0 , then {G}_{x} = - {G}_{x} , {G}_{y} = - {G}_{y} \qquad Equation ( 6 )$$

$$if {G}_{x} < 0 and {G}_{y} < 0 , then {G}_{x} = - {G}_{x} , {G}_{y} = - {G}_{y} \qquad Equation ( 7 )$$

As shown in equations (6) and (7), the angles in the second quadrant and the third quadrant can be converted to the first quadrant and the fourth quadrant.

Moreover, the gradient direction calculation element 2113 further performs the operations below so as to obtain the gradient direction PhaFlag:

$$If abs ( {G}_{x} ) + abs ( {G}_{y} ) < Th 1 , then PhaFlag = 8 \qquad Equation ( 8 )$$

$$Else if {G}_{x} \neq 0 and {G}_{y} = 0 , then PhaFlag = 0 \qquad Equation ( 9 )$$

$$Else if {G}_{x} = 0 and {G}_{y} \neq 0 , then PhaFlag = 4 \qquad Equation ( 10 )$$

$$Else if {G}_{y} > {G}_{x} * tan ( \frac{π}{16} ) and {G}_{y} \leq {G}_{x} * tan ( \frac{3 π}{16} ) , then PhaFlag = 1 \qquad Equation ( 11 )$$

$$Else if {G}_{y} > {G}_{x} * tan ( \frac{3 π}{16} ) and {G}_{y} \leq {G}_{x} * tan ( \frac{5 π}{16} ) , then PhaFlag = 2 \qquad Equation ( 12 )$$

$$Else if {G}_{y} > {G}_{x} * tan ( \frac{5 π}{16} ) and {G}_{y} \leq {G}_{x} * tan ( \frac{7 π}{16} ) , then PhaFlag = 3 \qquad Equation ( 13 )$$

$$Else if {G}_{y} > {G}_{x} * tan ( \frac{7 π}{16} ) and {G}_{y} \leq {G}_{x} * tan ( \frac{- 7 π}{16} ) , then PhaFlag = 4 \qquad Equation ( 14 )$$

$$Else if {G}_{y} > {G}_{x} * tan ( \frac{- π}{16} ) and {G}_{y} \leq {G}_{x} * tan ( \frac{π}{16} ) , then PhaFlag = 0 \qquad Equation ( 15 )$$

$$Else if {G}_{y} > {G}_{x} * tan ( \frac{- 3 π}{16} ) and {G}_{y} \leq {G}_{x} * tan ( \frac{- π}{16} ) , then PhaFlag = 7 \qquad Equation ( 16 )$$

$$Else if {G}_{y} > {G}_{x} * tan ( \frac{- 5 π}{16} ) and {G}_{y} \leq {G}_{x} * tan ( \frac{- 3 π}{16} ) , then PhaFlag = 6 \qquad Equation ( 17 )$$

$$Else if {G}_{y} > {G}_{x} * tan ( \frac{- 7 π}{16} ) and {G}_{y} \leq {G}_{x} * tan ( \frac{- 5 π}{16} ) , then PhaFlag = 5 \qquad Equation ( 18 )$$

As shown in equation (8), abs is an absolute value operation. If the gradient graphs Gₓ and G_{y} yield results smaller than a predetermined threshold Th1 after the calculation of equation (8), PhaFlag is 8, and it means that it's a flat region which is non-directed. For example, if a size of one pixel ranges between 0 and 255, the predetermined threshold Th1 can be set to 0.04*256, which is about 10.24. Moreover, as shown in equations (9) to (18), the corresponding gradient direction PhaFlag can be calculated according to the gradient graphs Gₓ and G_{y}.

In some embodiments, after the at least two gradient directions PhaFlag are obtained, the anisotropic calculation element 2115 performs standard deviation calculation on the at least two gradient directions PhaFlag to obtain a degree of anisotropy Aiso. For example, the anisotropic calculation element 2115 counts a strip vector bin[i] of the gradient direction PhaFlag in 8×8 neighborhoods according to the gradient direction PhaFlag, and counts the number of PhaFlag≠8 and regards it as an effective number vnum, thereby calculating the simplified standard deviation, as an equation below:

$$A i s o = \frac{{\sum }_{i = 0}^{7} ( abs ( bin [ i ] - a v g b i n ) )}{8 * Norm} \qquad Equation ( 19 )$$

In equation (19), Aiso is the degree of anisotropy, abs is an absolute value operation, bin[i] is the strip vector, avgbin is an average value of the strip vector, and Norm is a normalization parameter. A large degree of anisotropy indicates that a direction in the neighborhoods forms a main direction. A small degree anisotropy indicates that there is no prominent direction in the neighborhoods, and various directions are in undirected existences. A calculation equation for avgbin above is as below:

$$avgbin = \frac{{\sum }_{i = 0}^{7} b i n [ i ]}{v n u m} \qquad Equation ( 20 )$$

In equation (20), avgbin is an average value of the strip vector, bin[i] is the strip vector, and vnum is an effective number.

In some embodiments, the gradient magnitude calculation element 2117 obtains a gradient magnitude GradMad according to the least two gradient graphs Gₓ and G_{y}. For example, an equation for the gradient magnitude GradMad is as follows:

$$GradMad = max ( abs ( {G}_{x} ) , abs ( {G}_{y} ) ) \qquad Equation ( 21 )$$

As shown in equation (21), GradMad is the gradient magnitude, max is a maximum value operation, and abs is an absolute value operation.

In some embodiments, a calculation equation for a degree of isotropy is as below:

$$i s o = 1 - Aiso \qquad Equation ( 22 )$$

In equation (22), iso is the degree of isotropy, and Aiso is the degree of anisotropy.

In some embodiments, after the gradient magnitude GradMad and the isotropy iso are obtained, the texture confidence calculation element 2119 calculates a texture confidence Tmap according to the gradient magnitude GradMad and the isotropy iso. For example, an equation for the texture confidence Tmap is as below:

$$Tmap = GradMad * iso \qquad Equation ( 23 )$$

In equation (23), Tmap is the texture confidence, GradMad is the gradient magnitude, and iso is the degree of isotropy. As shown in equation (23), the texture Tmap needs to have a certain gradient as well as undirected property. For a region having a high texture confidence, the present application is able to save a rate by bit rate control without incurring severe deterioration in subjective viewing quality. The region having a high texture confidence described above usually occurs in a region with chaotic directions and a large gradient magnitude.

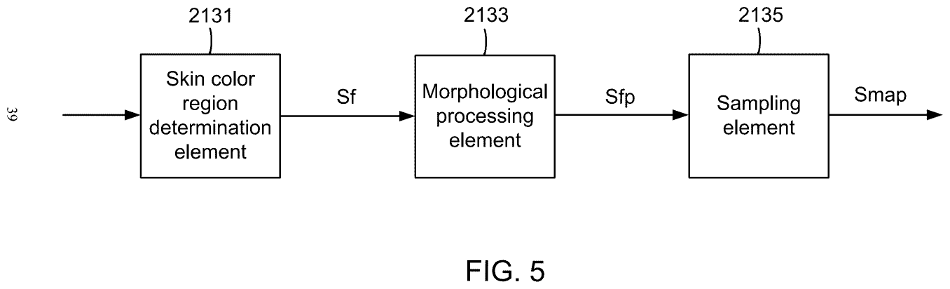

In some embodiments, referring to FIG. 2, the confidence calculation circuit 210 includes a person confidence calculator 213. To better understand the operation of the person confidence calculator 213, referring to both FIG. 2 and FIG. 5, FIG. 5 shows a schematic diagram of the person confidence calculator 213 according to some embodiments of the present application. The person confidence calculator 213 includes a skin color region determination element 2131, a morphological processing element 2133 and a sampling element 2135.

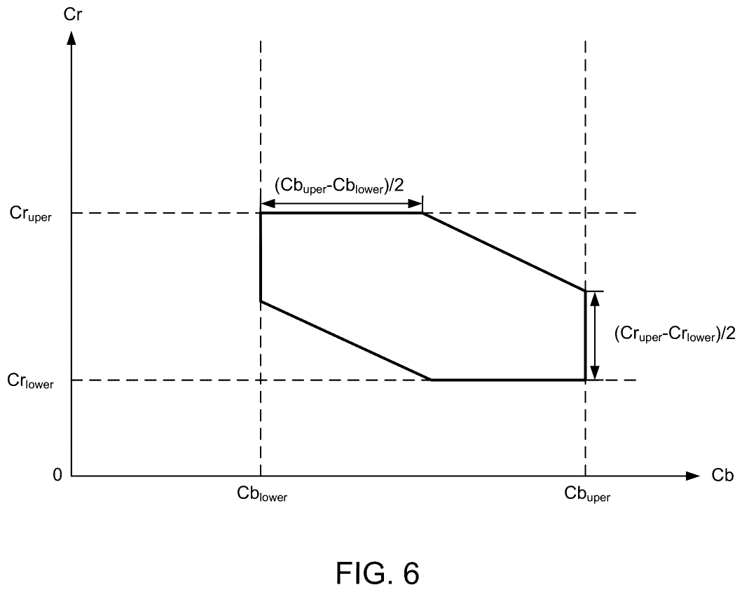

In some embodiments, the skin color region determination element 2131 performs skin color determination on an image to generate a skin color region Sf. For example, under an original resolution, the skin color region determination element 2131 performs skin color determination by using a blue chrominance Cb and a red chrominance Cr. To better understand the method for determining the skin color region Sf, referring to both FIG. 5 and FIG. 6, FIG. 6 shows a schematic diagram of a skin color region according to some embodiments of the present application. The skin color region determination element 2131 may perform skin color determination according to the blue chrominance Cb and the red chrominance Cr. In order to reduce misjudgment, the skin color region Sf of the present application may be determined by using a hexagon in the drawing. As shown in FIG. 6, the skin color region determination element 2131 defines the hexagon formed by setting an upper limit Cbᵤₚₑᵣ and a lower limit Cb_{lower} of the blue chrominance Cb, an upper limit Crᵤₚₑᵣ and a lower limit Cr_{lower} of the red chrominance, a half of a difference between the upper and lower limits of the blue chrominance Cb (Cbᵤₚₑᵣ−Cb_{lower})/2, and a half of a difference between the upper and lower limits of the red chrominance Cr (Crᵤₚₑᵣ−Cr_{lower})/2. According to the setting above, determination equations of the skin color region determination element 2131 are as below:

$$C {b}_{lower} \leq {P}_{Cb} \leq C {b}_{uper} \qquad Equation ( 24 )$$

$$C {r}_{l ower} \leq {P}_{Cr} \leq C {r}_{uper} \qquad Equation ( 25 )$$

$$( C {b}_{uper} - C {b}_{lower} ) * {P}_{C r} \geq ( C {r}_{lower} - C {r}_{uper} ) * {P}_{Cb} + ( C {r}_{lower} + C {r}_{uper} ) * \frac{( {Cb}_{uper} - {Cb}_{lower} )}{2} - {Cb}_{lower} * ( C {r}_{lower} - C {r}_{uper} ) \qquad Equation ( 26 )$$

$$( {Cb}_{uper} - C {b}_{lower} ) * {P}_{C r} \leq ( C {r}_{lower} - C {r}_{uper} ) * {P}_{Cb} + ( C {r}_{lower} + C {r}_{uper} ) * \frac{( {Cb}_{u p e r} - {Cb}_{lower} )}{2} + {Cb}_{uper} * ( C {r}_{uper} - C {r}_{lower} ) \qquad Equation ( 27 )$$

As shown in equations (24) and (25), to determine an input image to have a skin color, a target blue chrominance P_{Cb} thereof needs to be between the upper limit Cbᵤₚₑᵣ and the lower limit Cb_{lower} of the blue chrominance Cb, a target red chrominance P_{Cr} thereof needs to be between the upper limit Crᵤₚₑᵣ and the lower limit Cr_{lower} of the red chrominance Cr, and the target blue chrominance P_{Cb} and the target red chrominance P_{Cr} need to satisfy equations (26) and (27). The skin color region determination element 2131 performs skin color determination on the image according to the setting above to generate a skin color region Sf.

Referring to FIG. 5, after the skin color region Sf is obtained, the morphological processing unit 2133 performs morphological processing on the skin color region Sf to generate a morphological processing result Sfp. For example, the morphological processing element 2133 performs a morphological opening operation on the skin color region Sf, that is, first eroding and then dilating, as equations below:

$$Sfp = dilate ( erode ( Sf , el ) , el ) \qquad Equation ( 28 )$$

In equation (28), Sfp is a morphological processing result, dilate is a dilation operation, erode is an erosion process, Sf is the skin region, and el is as follows:

$$el = [ \begin{matrix}1 & 1 & 1 \\ 1 & 1 & 1 \\ 1 & 1 & 1\end{matrix} ] \qquad Equation ( 29 )$$

In some embodiments, after the morphological processing result Spf is obtained, the sampling element 2135 samples the morphological processing result Spf to obtain a person confidence Smap. For example, the sampling element 2135 performs 4× sampling on the morphological processing result Spf to obtain the person confidence Smap, as an equation below:

$$Smap = \frac{{\sum }_{i = 0}^{3} {\sum }_{j = 0}^{3} Sfp ( i , j )}{16} \qquad Equation ( 30 )$$

In equation (30), Smap is the person confidence, and Sfp is the morphological processing result.

In some embodiments, referring to FIG. 2, the motion confidence calculator 215 samples a plurality original macroblocks of an original frame of the image and a plurality of previous macroblocks of a previous frame of the original frame. For example, the motion confidence calculator 215 performs 8× sampling on the original frame of the image and the previous frame to generate an original frame macroblock and a previous frame macroblock.

Next, the motion confidence calculator 215 calculates a frame difference according to the original frame macroblock and the previous frame macroblock. For example, the motion confidence calculator 215 calculates a frame difference between the original frame macroblock and the previous frame macroblock, as an equation below:

$$DiffMask ( i , j ) = \{ \begin{matrix}1 , & abs ( Y ( i , j ) - {Y}_{pre} ( i , j ) ) > Th 2 \\ 0 , & others\end{matrix} \qquad Equation ( 31 )$$

In equation (31), Diffmask (i, j) is the frame difference, abs is an absolute value operation, Y(i, j) is the original frame macroblock, Yₚᵣₑ(i, j) is the previous frame macroblock, and Th2 is a predetermined threshold. For example, if a size of one pixel ranges between 0 and 255, the predetermined threshold Th2 can be set to 0.1*256, which is about 25.6. In i∈(0, W/8-1) above, j∈(0, H/8-1), W is a macroblock width, and H is a macroblock length.

Then, the motion confidence calculator 215 calculates the motion confidence according to the frame difference Diffmask(i, j). For example, the motion confidence calculator 215 calculates the motion confidence within a range of a coding unit (CU) 32 according to the frame difference Diffmask(i, j), wherein a size of the coding unit CU 32 is 32×32, and an equation for the above is as below:

$$Mmap = \frac{{\sum }_{i = 0}^{3} {\sum }_{j = 0}^{3} Diffmask ( i , j )}{16} \qquad Equation ( 32 )$$

In equation (32), Mmap is the motion confidence, and Diffmask(i, j) is the frame difference.

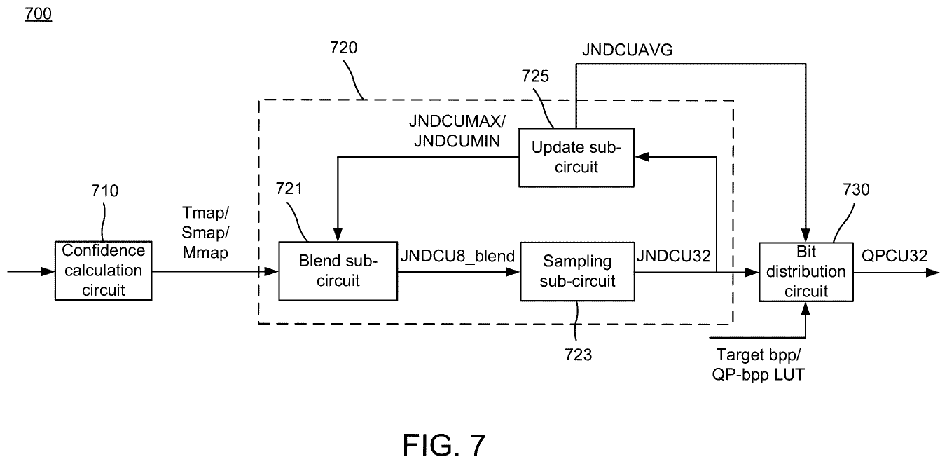

Referring to FIG. 2, to better understand the operations of the blend calculation circuit 220 and the bit distribution circuit 230, referring to both FIG. 2 and FIG. 7, FIG. 7 shows a schematic diagram of a bit rate control device 700 according to some embodiments of the present application. Compared to the bit rate control device 200 in FIG. 2, a blend calculation circuit 720 of the bit rate control device 700 in FIG. 7 further includes a blend sub-circuit 721, a sampling sub-circuit 723 and an update sub-circuit 725. It should be noted that, the structure and operations of the confidence calculation circuit 710 shown in FIG. 7 are similar to those of the confidence calculation circuit 210 in FIG. 2, and such repeated details are omitted herein.

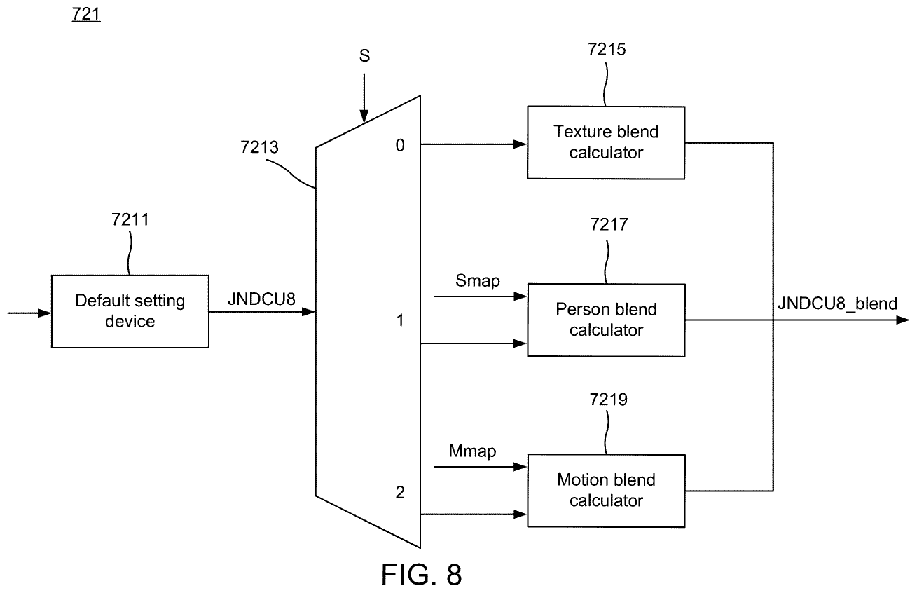

Referring to FIG. 7, to better understand the operation of the blend sub-circuit 721 of the blend calculation circuit 720, referring to both FIG. 7 and FIG. 8, FIG. 8 shows a schematic diagram of the blend sub-circuit 721 according to some embodiments of the present application. The blend sub-circuit 721 includes a default setting device 7211, a selector 7213, a texture blend calculator 7215, a person blend calculator 7217 and a motion blend calculator 7219.

First of all, the default setting device 7211 sets the texture confidence Tmap as a default value. For example, the default setting device 7211 receives the texture confidence Tmap transmitted from the confidence calculation circuit 710, and sets the texture confidence Tmap as a default value, with an equation as below:

$$JNDCU8 ( i , j ) = Tm ap ( i , j ) \qquad Equation ( 33 )$$

In equation (33), JNDCU8(i, j) is the default value, and Tmap(i, j) is the texture confidence.

In some embodiments, the selector 7213 transmits the default value to the texture blend calculator 7215, the person blend calculator 7217 or the motion blend calculator 7219 according to a mode selection signal S. Referring to both FIG. 7 and FIG. 8, the mode selection signal S may be automatically set by the bit rate control device 700. For example, the bit rate control device 700 may include a person confidence threshold and a motion confidence threshold. When the person confidence is greater than the person confidence threshold, the bit rate control device 700 accordingly sets the mode selection signal S, so as to transmit its output to the person blend calculator 7217. When the motion confidence is greater than the motion confidence threshold, the bit rate control device 700 accordingly sets the mode selection signal S, so as to transmit its output to the motion blend calculator 7219.

Moreover, the mode selection signal S may also be set by a user. Assuming that an image to be watched by a user is an interview talk show, the user may set the person confidence to perform the subsequent bit distribution. Alternatively, if an image to be watched by a user is a sports game, the user may set the motion confidence to perform the subsequent bit distribution.

Then, the selector 7213 may transmit the default value JDNCU8 to the texture blend calculator 7215, the person blend calculator 7217 or the motion blend calculator 7219 according to the mode selection signal S, so as to perform blend calculation.

A so-called just-noticeable distortion (JND) in the default value JDNCU8 is an error between a decoded signal and a real signal when a user is just able to subjectively notice a quality deterioration. The just-noticeable distortion JND increases as the texture confidence of a region increases. The just-noticeable distortion JND decreases as the person confidence of a region increases. The just-noticeable distortion JND decreases as the motion confidence of a region increases. Adjustment may be made for a region having a large JND so as to save code words, and to provide more code word resources for a region having a small JND.

The blend sub-circuit 721 in FIG. 8 of the present application is able to select a corresponding blend calculator according to a scenario (for example, an interview talk show or a sports game) to be watched by a user, so as to perform blend calculation of the just-noticeable distortion JND and generate the corresponding blend parameter, further effectively performing oblique distribution to improve subjective viewing quality for the user. Related details are as given in the description below.

Referring to FIG. 8, in some embodiments, the texture blend calculator 7215 sets the texture confidence as a blend parameter in response to the mode selection signal S. For example, the selector 7213 may transmit the default value JNDCU8 to the texture blend calculator 7215 according to the mode selection signal S, that is, transmitting the texture confidence to the texture blend calculator 7215. Then, the texture blend calculator 7215 may directly use the texture confidence as the blend parameter JNDCU8_blend, so as to perform a subsequent bit distribution operation.

In some embodiments, the person blend calculator 7217 calculates a person flatness according to the texture confidence in response to the mode selection signal S. For example, if the person confidence Smap is greater than the person confidence threshold, the person blend calculator 7217 adjusts a region corresponding to the person confidence Smap greater than the person confidence threshold. Associated details are as given in the description below. First of all, the selector 7213 may transmit the default value JNDCU8 to the person blend calculator 7217 according to the mode selection signal S, that is, transmitting the texture confidence to the person blend calculator 7215. Then, the person blend calculator 7217 calculates the person flatness according to the texture confidence, as an equation below:

$$flatRatio 1 ( i , j ) = 1 - \frac{\begin{matrix}CLIP ( Tmap ( i , j ) - JNDCUMIN , 0 \\ JNDCUMAX - JNDCUMIN )\end{matrix}}{JNDCUMAX - JNDCUMIN} \qquad Equation ( 34 )$$

In equation (34), flatRatio1(i, j) is the person flatness, Tmap (i, j) is the texture confidence, JNDCUMAX and JNDCUMIN represent a maximum value and a minimum value in the previous frame macroblock JNDCU32 of the input image, CLIP is a specified range operation so as to limit a difference (Tmap (i, j)−JNDCUMIN) to be within a range between 0 and (JNDCUMAX−JNDCUMIN).

In some embodiments, after the person flatness is obtained, the person blend calculator 7217 performs blend calculation according to the texture confidence, a person reinforcement parameter and the person flatness to generate the blend parameter. For example, an equation of the above blend parameter is as below:

$$JNDCU8\_blend ( i , j ) = JNDCU 8 ( i , j ) - sstr * flatRatio 1 * ( JNDCU 8 ( i , j ) - JNDCUMIN ) \qquad Equation ( 35 )$$

In equation (35), JNDCU8_blend(i, j) is the blend parameter, JNDCU8(i, j) is the texture confidence, sstr is the person reinforcement parameter, and flatRatio1 is the person flatness. The person reinforcement parameter sstr ranges between 0 and 1 and determines an intensity of a person reinforcement style, wherein an intensity of the person reinforcement style gets larger as a value of the person reinforcement parameter sstr increases.

In some embodiments, the motion blend calculator 7219 calculates a motion flatness according to the texture confidence in response to the mode selection signal S. For example, if the motion confidence Mmap is greater than the motion confidence threshold, the motion blend calculator 7219 adjusts a region corresponding to the motion confidence Mmap greater than the motion confidence threshold. Associated details are as given in the description below. First of all, the selector 7213 may transmit the default value JNDCU8 to the motion blend calculator 7219 according to the mode selection signal S, that is, transmitting the texture confidence to the motion blend calculator 7219. Then, the motion blend calculator 7219 calculates the motion flatness according to the texture confidence, as an equation below:

$$flatRatio 2 ( i , j ) = 1 - \frac{\begin{matrix}CLIP ( Tmap ( i , j ) - JNDCUMIN , 0 , \\ JNDCUMAX - JNDCUMIN )\end{matrix}}{JNDCUMAX - JNDCUMIN} \qquad Equation ( 36 )$$

Compared to equation (34), in equation (36), flatRatio2(i, j) is the motion flatness, and the remaining parameters are described in equation (34) and related details are omitted herein.

In some embodiment, after the motion flatness is obtained, the motion blend calculator 7219 performs blend calculation according to the texture confidence, the motion reinforcement parameter and the motion flatness to generate the blend parameter. For example, an equation for the blend parameter above is as below:

$$JNDCU8\_blend ( i , j ) = JNDCU 8 ( i , j ) - mstr * flatRatio 2 * ( JNDCU 8 ( i , j ) - JNDCUMIN ) \qquad Equation ( 37 )$$

Compared to equation (35), in equation (37), mstr is the motion reinforcement parameter, and flatRatio2 is the motion flatness. The motion reinforcement parameter mstr ranges between 0 and 1 determines an intensity of a motion reinforcement style, wherein an intensity of the motion reinforcement style gets larger as a value of the motion reinforcement parameter mstr increases. The remaining parameters are described in equation (35) and related details are omitted herein.

Referring to FIG. 7, the sampling sub-circuit 723 samples the blend parameter JNDCU8_blend, as an equation below:

$$JNDCU 32 = \frac{{\sum }_{i = 0}^{3} {\sum }_{j = 0}^{3} JNDCU8\_blend ( i , j )}{16} \qquad Equation ( 38 )$$

In equation (38), JNDCU32 is the sampling parameter, and JNDCU8_blend is the blend parameter.

Referring to FIG. 7, after the sampling parameter JNDCU32 is obtained, the update sub-circuit 725 updates the maximum value JNDCUMAX, the minimum value JNDCUMIN and an average value JNDCUAVG, with update settings as below:

$$If JNDCU 32 > JNDCUMAX , \qquad Equation ( 39 )$$

$$then JNDCUMAX = JNDCU 32$$

$$If JNDCU 32 < JNDCUMIN , \qquad Equation ( 40 )$$

$$then JNDCUMIN = JNDCU 32$$

$$JNDCUAVG = {\sum }_{i = 0}^{\frac{W}{32} - 1} {\sum }_{j = 0}^{\frac{H}{32} - 1} JNDCU 32 ( i , j ) \qquad Equation ( 41 )$$

It should be noted that, the maximum value JNDCUMAX and the minimum value JNDCUMIN used for calculation of the original frame are both obtained from the previous frame of the image.

Referring to FIG. 7, after the sampling parameter JNDCU32 of the blend parameter JNDCU8_blend is obtained, the bit distribution circuit 730 calculates a bits per pixel (bpp) of each macroblock CU32 according to the sampling parameter JNDCU32 of the blend parameter JNDCU8_blend and a target bits per pixel output from the frame-level bit rate control device 110 in FIG. 1.

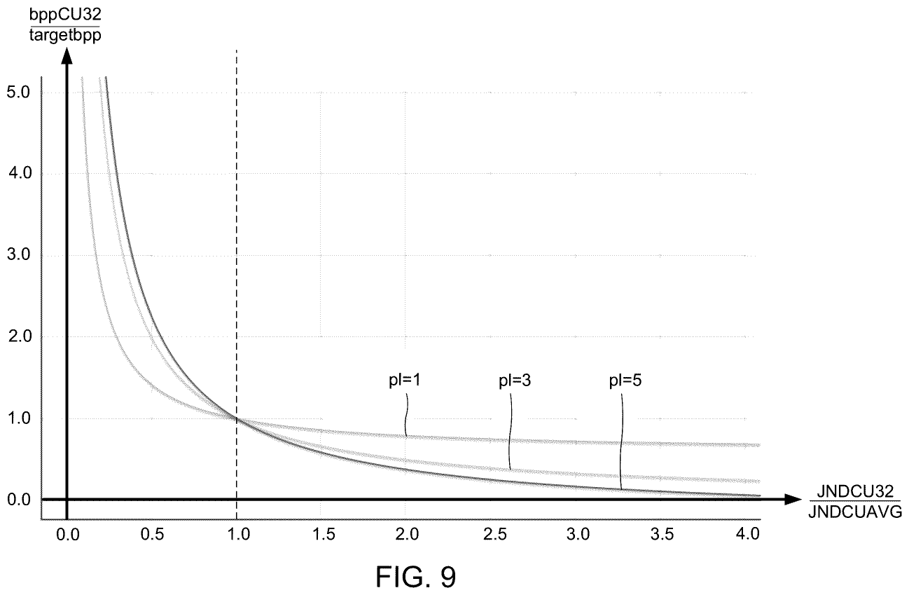

For example, first of all, it is defined that pl is an adjustment strength and a range of the adjustment strength pl ranges between 1 and 5. To better understand the adjustment strength pl, referring to FIG. 9, FIG. 9 shows a schematic diagram of the adjustment strength pl according to some embodiments of the present application. As shown in FIG. 9, the strength decreases as a value increases, and this adjustment strength pl may be set by a user. As the strength of the adjustment strength pl increases, a distribution range of the quantization parameter QP in an image gets larger. As the strength of the adjustment strength pl decreases, a distribution range of the quantization parameter QP in the image gets smaller. An equation of the bits per pixel of each macroblock CU32 is as below:

$$bppCU 32 = tbpp * \frac{max ( \frac{JNDCUAVG}{JNDCU 32} + pstr , 0 )}{pstr + 1} \qquad Equation ( 42 )$$

In equation (42), bppCU32 is the bits per pixel of each macroblock CU32, tbpp is the target bits per pixel output from the frame-level bit rate control device 110 in FIG. 1, JNDCUAVG is the average value output from the update sub-circuit 725, and JNDCU32 is the sampling parameter. In FIG. 9, the vertical-axis coordinate in the drawing of the adjustment strength pl is associated with a ratio of the bits per pixel to the target bits per pixel, the horizontal-axis coordinate is a ratio of the sampling parameter JNDCU32 to the average value JNDCUAVG output from the update sub-circuit 725. Moreover, an equation for pstr in equation (42) is as below:

$$pstr = \{ \begin{matrix}0.7 * ( pl - 3 ) , & if ( pl - 3 ) > 0 \\ 0.1 * ( pl - 3 ) , & otherwise\end{matrix} \qquad Equation ( 43 )$$

In some embodiments, after the bits par pixel bbpCU32 of each macroblock CU32 is obtained, the bit distribution circuit 730 obtains a quantization parameter QCPU32 corresponding to the bits per pixel of the macroblock CU32 according to the quantization parameter QP output from the frame-level bit rate control device 110 in FIG. 1 and a look-up table QP-bpp LUT of the bits per pixel, as the bit distribution parameter. The look-up table QP-bpp LUT may be obtained by an R-Q model. An equation for the quantization parameter QPCU32 is as below:

$$QPCU 32 = LUT ( bppCU 32 ) \qquad Equation ( 44 )$$

In equation (44), QPCU32 is the corresponding quantization parameter, LUT is a look-up table operation, and bppCU32 is the bits per second of the macroblock CU32. After the quantization parameter QPCU32 corresponding to the bits per pixel of the macroblock CU32 is obtained, the bit control device 700 of the present application may accordingly perform the subsequent bit distribution.

In some embodiments, after the quantization parameter QPCU32 is obtained, the bit distribution circuit 730 defines a range of the quantization parameter QPCU32, as an equation below:

$$QPCU 32 = CLIP ( QP avg - DQP , QPavg + DQP ) \qquad Equation ( 45 )$$

In equation (45), QPCU32 is the corresponding quantization parameter, CLIP is described in equation (34) and related details are omitted herein, QPavg is an average quantization parameter, and DQP is a quantization parameter difference.

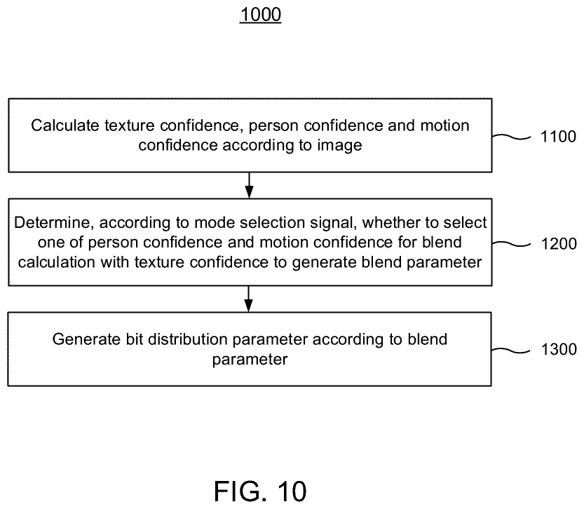

FIG. 10 shows a flowchart of a bit rate control method 1000 according to some embodiments of the present application. To better understand the bit rate control method 100, referring to both FIG. 2 and FIG. 10.

Referring to step 1100, a texture confidence, a person confidence and a motion confidence may be calculated by the confidence calculation circuit 210 according to an image.

Referring to step 1200, according to a mode selection signal, it may be determined by the blend calculation circuit 220 whether to select one of the person confidence and the motion confidence for blend calculation with the texture confidence to generate a blend parameter.

Referring to step 1300, a bit distribution parameter may be generated by the bit distribution circuit 230 according to the blend parameter. It should be noted that, operation details of steps 1100 to 1300 of the bit rate control method 1000 are given in the description associated with the embodiments in FIG. 1 to FIG. 9, and such repeated details are omitted herein for brevity of the present application.

It should be noted that, the present application is not limited to the embodiments shown in FIG. 1 to FIG. 10, and are merely examples of implementations of the present application. To better understand the technical contents of the present application, the scope of protection of the present application is to be accorded with the broadest interpretation of the appended claims. Without departing from the spirit of the present application, all modifications and variations made to the embodiments of the present application by a person skilled in the art are to be encompassed within the scope of protection of the present application. Devices, circuits, calculators, elements and the like shown in the present application may be implemented by hardware, or may be implemented by a processor executing software, depending on actual requirements.

In conclusion, the bit rate control device and the bit rate control method of the present application, in response to different application scenarios, are able to selectively determine whether to select one of the person confidence and the motion confidence for blend calculation with the texture confidence to generate a blend parameter and then accordingly determine an encoding parameter such as a bit distribution parameter, thereby improving viewing quality of a person part (for example, a human face) of a motion part.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A bit rate control device, comprising:
a confidence calculation circuit, calculating a texture confidence, a person confidence and a motion confidence according to an image;
a blend calculation circuit, determining, according to a mode selection signal, whether to select one of the person confidence and the motion confidence for blend calculation with the texture confidence to generate a blend parameter; and
a bit distribution circuit, generating a bit distribution parameter according to the blend parameter.

2. The bit rate control device according to claim 1, wherein the blend calculation circuit comprises:
a person blend calculator, calculating a person flatness according to the texture confidence in response to the mode selection signal, and performing the blend calculation according to the texture confidence, a person reinforcement parameter and the person flatness to generate the blend parameter.

3. The bit rate control device according to claim 1, wherein the blend calculation circuit comprises:
a motion blend calculator, calculating a motion flatness according to the texture confidence in response to the mode selection signal, and performing the blend calculation according to the texture confidence, a motion reinforcement parameter and the motion flatness to generate the blend parameter.

4. The bit rate control device according to claim 1, wherein the blend calculation circuit comprises:
a texture blend calculator, setting the texture confidence as the blend parameter in response to the mode selection signal;
a person blend calculator, configured to perform the blend calculation on the person confidence and the texture confidence to generate the blend parameter; and
a motion blend calculator, configured to perform the blend calculation on the motion confidence and the texture confidence to generate the blend parameter.

5. The bit rate control device according to claim 4, wherein the blend calculation circuit further comprises:
a selector, transmitting the texture confidence to one of the texture blend calculator, the person blend calculator and the motion blend calculator according to the mode selection signal.

6. The bit rate control device according to claim 1, wherein when the person confidence is greater than a person confidence threshold, the blend calculation circuit generates the blend parameter from the person confidence and the texture confidence according to the mode selection signal; when the motion confidence is greater than a motion confidence threshold, the blend calculation circuit generates the blend parameter from the texture confidence and the motion confidence according to the mode selection signal.

7. The bit rate control device according to claim 1, wherein the confidence calculation circuit comprises:
a texture confidence calculator, performing convolution on the image to obtain at least two gradient graphs, calculating at least two gradient directions according to the at least two gradient graphs, and performing standard deviation calculation on the at least two gradient directions to obtain a degree of anisotropy, wherein the texture confidence calculator further obtains a gradient magnitude and a degree of isotropy according to the at least two gradient graphs and the degree of anisotropy, and calculates the texture confidence according to the gradient magnitude and the degree of isotropy.

8. The bit rate control device according to claim 1, wherein the confidence calculation circuit comprises:
a person confidence calculator, performing skin color determination on the image to generate a skin color region, performing morphological processing on the skin color region to generate a morphological processing result, and sampling the morphological processing result to obtain the person confidence.

9. The bit rate control device according to claim 1, wherein the confidence calculation circuit comprises:
a motion confidence calculator, sampling a plurality of original-frame macroblocks of an original frame of the image and a plurality of previous-frame macroblocks of a previous frame of the original frame, calculating a plurality of frame differences according to the original-frame macroblocks and the previous-frame macroblocks, and calculating the motion confidence according to the frame differences.

10. A bit rate control method, applied to a bit rate control device, the method comprising:
calculating a texture confidence, a person confidence and a motion confidence according to an image;
determining, according to a mode selection signal, whether to select one of the person confidence and the motion confidence for blend calculation with the texture confidence to generate a blend parameter; and
generating a bit distribution parameter according to the blend parameter.
